(19) United States
(12) Patent Application Publication
(10) Pub. No.: US 2013/0320603 A1
(43) Pub. Date: Dec. 5, 2013

(54) PISTON FOR AN AIR SPRING

(71) Applicant: Ulrich Orlamünder, Gehrden (DE)

(72) Inventor: Ulrich Orlamünder, Gehrden (DE)

(73) Assignee: CONTINENTAL TEVES AG & CO. oHG, Frankfurt (DE)

(21) Appl. No.: 13/984,661

(22) PCT Filed: Jan. 25, 2012
(86) PCT No.: PCT/EP12/51095

§ 371 Date: Aug. 9, 2013

(30) Foreign Application Priority Data
Feb. 11, 2011 (DE) 10 2011 003 992.9
Oct. 27, 2011 (DE) 10 2011 085 323.5

(51) Int. Cl. F16F 9/05

(52) U.S. Cl. CPC F16F 9/057
USPC 267/124

(57) ABSTRACT

The invention relates to a piston for an air spring, wherein the piston has a piston skirt, wherein the outer contour of the piston skirt can be variably changed in order to vary an air spring characteristic of the air spring.

### CROSS REFERENCE TO RELATED APPLICATIONS

This application is the U.S. National Phase Application of PCT International Application No. PCT/EP2012/051095, filed Jan. 25, 2012, which claims priority to German Patent Application No. 10 2011 003 992.9, filed Feb. 11, 2011 and German Patent application No. 10 2011 085 323.5, filed Oct. 27, 2011, the contents of such applications being incorporated by reference herein.

### FIELD OF THE INVENTION

The invention relates to a piston for an air spring, to an air spring having a piston and to an interchangeable shell for a piston.

### BACKGROUND OF THE INVENTION

Springs are capable of absorbing work over a relatively large travel in order to store said work completely or partially as deformation energy. A distinction is drawn here between an elastic change of shape and an elastic change of volume. In the case of an elastic change of shape, the material of the spring is deformed on the basis of its inherent elasticity and, in the process, absorbs energy, whereas, in the case of an elastic change of volume, the spring action is based on volume and hence on a change in the pressure of the elastic medium. The most well-known types of spring based on the principle of an elastic change of volume are gas springs and air springs. Here, the elastic medium used is, in particular, air or nitrogen enclosed by a container, wherein said gas is compressed by externally acting forces. This results in a change in volume, wherein the travel required to change the volume and the force to compress the gas depend on various factors.

The behavior of an air spring when subjected to a force is described technically by the air spring characteristic of the air spring. The air spring characteristic depends on the size and shape of the air spring bellows of the air spring, the choice of material for said bellows and also on the size and shape of the piston of the air spring. DE 20 2005 006 027 U1, which is incorporated by reference, for example, shows a piston of a motor vehicle air spring with a buffer.

### SUMMARY OF THE INVENTION

Given the above, an aspect of the invention provides an improved piston for an air spring, an improved air spring and an interchangeable shell for a piston.

The aspects of the invention are achieved by means of the features in the independent patent claims. Preferred embodiments of the invention are indicated in the dependent patent claims.

A piston for an air spring is presented, wherein the piston has a piston skirt, wherein the outer contour of the piston skirt can be variably modified in order to modify an air spring characteristic of the air spring.

Embodiments of the invention have the advantage that the air spring characteristic can be implemented by way of the contouring of the air spring piston itself. Here, the contour is not installed in a fully fixed manner in the piston itself, but the contour of the piston skirt can be modified and, on the basis of this modification of the outer contour of the piston skirt, the air spring characteristic of the air spring can likewise be modified in a desired manner.

It would therefore be possible, for example, to adjust the air spring characteristic of the resulting air spring flexibly to corresponding customer requirements, using a universal set comprising a piston and an air spring bellows. For this purpose, only the outer contour of the piston skirt is variably modified, thereby ensuring that the resulting air spring characteristic of the air spring corresponds to customer requirements.

In the case of an air spring, the change in the spring force with the spring travel, for example, is determined inter alia by two design variables of the air spring, namely the piston contour and the volume. Here, the force, as the product of the internal pressure and the effective area, increases with increasing pressure. Thus, one way of influencing the increase in force during compression is the area on which the pressure acts. Now, the size of this area depends on the outer contour of the piston skirt and, in particular, a piston with a non-cylindrical contour has the effect of changing the effective area during compression and rebound. By modifying this outer contour, it is thus possible to adjust the spring behavior of the air spring in any desired manner. According to the present invention, it is not necessary for this purpose to replace the entire piston for the air spring, it being sufficient to provide a main body of a piston, with the outer contour of said main body being variably modifiable.

According to one embodiment of the invention, the outer contour of the piston skirt, i.e. of the main body, can be modified by means of an interchangeable shell. For example, the piston has means for fixing an interchangeable shell, wherein the outer contour can be modified by fixing the interchangeable shell on the piston. The interchangeable shell thus forms a kind of “adapter”, which can be mounted on the main body in order in this way to define a new outer contour of the piston skirt.

It would thus be possible, by providing a main body of a piston, to variably implement a large number of different air spring characteristics of an air spring in a financially advantageous manner, merely by mounting a suitable interchangeable shell on the main body.

According to one embodiment of the invention, the piston is designed to receive the interchangeable shell by sliding the latter onto the piston skirt. This could have the advantage, in particular, of simple mechanical assembly of the resulting air spring.

According to another embodiment of the invention, the means for fixing have latching means. In comparison with a screwed joint, for example, it would thereby also be possible to obtain simplified mechanical assembly of the air spring.

According to another embodiment of the invention, the piston together with the interchangeable shell can be connected in an airtight manner to an air spring bellows. For example, the piston with the interchangeable shell can be connected to the air spring bellows by means of a clamping ring. For this purpose, for example, the piston can have a sealing taper, wherein the sealing taper is designed to allow the airtight connection of the piston to the interchangeable shell and the air spring bellows by means of the clamping ring.

Overall, the clamping ring could offer an elegant way of establishing the airtight connection between the air spring bellows, the piston and the interchangeable shell, irrespective of the actual shape of the interchangeable shell itself.

According to one embodiment of the invention, the piston together with the interchangeable shell can be connected in an airtight manner to the air spring bellows by pressing the clamping ring onto the interchangeable shell and thereby pressing the interchangeable shell onto the air spring bellows. Thus, the air spring bellows is thereby fixed between the main body of the piston and the interchangeable shell without the risk of direct mechanical stress on the air spring bellows due to the clamping ring. The clamping ring thus does not cut into the mechanically more flexible air spring bellows, thereby weakening the latter. In particular, this also allows large-area clamping of the air spring bellows between the main body of the piston and the interchangeable shell.

According to another embodiment of the invention, the outer contour can be modified by mechanically distorting the outer contour of the piston skirt. As an alternative or in addition, therefore, to the use of an interchangeable shell, it is also possible for the outer contour of the piston skirt either to be modified by deforming the piston skirt mechanically from the inside outward or for the piston skirt to have mechanical elements which can be moved mechanically outward. The latter possibility can be implemented, for example, by using appropriate motors, e.g. piezoelectric motors. Mechanical deformation of the piston skirt would be possible by changing the pressure within the piston, achievable, for example, by means of pneumatic elements which bring about a specific pressure action on the piston skirt.

According to another aspect, the invention relates to an air spring having a piston as described above.

According to another aspect, the invention relates to an interchangeable shell for a piston described above.

### BRIEF DESCRIPTION OF THE DRAWINGS

The invention is best understood from the following detailed description when read in connection with the accompanying drawings. Included in the drawings is the following figures:

FIG. 1 shows an air spring in a cross-sectional view,

FIG. 2 shows various shapes of piston for an air spring,

FIG. 3 shows a piston with a main body and an interchangeable shell.

### DETAILED DESCRIPTION OF THE PREFERRED EMBODIMENTS

Elements that are similar to one another are indicated by the same reference signs below.

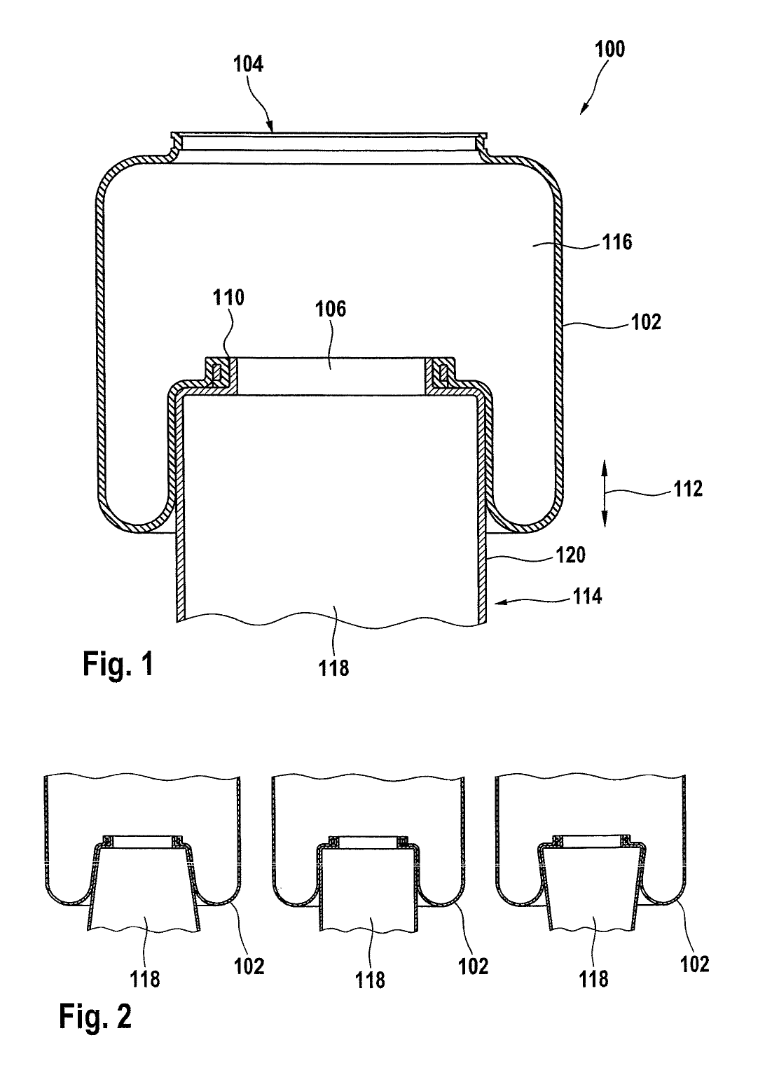

FIG. 1 shows an air spring 100 having a piston 118 and an air spring bellows 102. The air spring bellows 102 is connected airtightly to the piston 118 in region 110. Here, region 110 is the upper region of the piston 118, wherein the upper region 118 is bounded by a clamping plate 106, for example.

The piston 118 can move in the interior 116 of the air spring bellows 102 in direction 112. For this purpose, the air spring bellows is connected by the beveled plate 104 thereof as connecting part to the load to be provided with spring support, wherein the tube formed by the air spring bellows 102 is closed at the top by the plate 104.

The piston 118, on the other hand, closes the air spring bellows 102 at the bottom. The air spring bellows 102 is normally a tubular component made of elastomeric material.

On the underside 114, the piston 118 has a means of connecting it to a vehicle axle when used in a vehicle, for example. Thus, the piston 100 shown in FIG. 1 can be installed in a vehicle, e.g. a motor vehicle or a rail vehicle, in such a way that the plate 104 is connected to the vehicle body and the underside 114 is connected to the axle of the vehicle.

The piston 118 has an outer contour 120. As the piston 118 is pushed into the air spring bellows, the outer contour 120 defines the area which is effective during this “compression”, the area on which the pressure in the interior 116 of the air spring 100 acts. Here, the interior 116 is filled with a gas.

FIG. 2 shows various shapes of piston 118 that can be pushed into an air spring bellows 102. The piston 118 shown on the left-hand side of FIG. 2 has a frustoconical shape, wherein the diameter of the shape tapers in the direction of the beveled plate 104. As the piston 118 is pushed into the air spring bellows 102, the area on which the pressure acts increases continuously. During rebound, i.e. as the piston 118 moves out of the air spring bellows 102, on the other hand, the effective area decreases continuously again. Overall, a characteristic air spring characteristic of this air spring is thereby obtained.

In the variant of the piston 118 shown in the middle in FIG. 2, said piston has a purely cylindrical contour, whereas the outer contour of the piston skirt of the piston 118 in the embodiment shown on the right-hand side of FIG. 2 once again has a frustoconical shape. to However, the diameter of the frustoconical shape increases in the direction of the beveled plate 104.

If the central embodiment and the right-hand embodiment in FIG. 2 are compared directly, it becomes clear that, as the piston 118 of the right-hand embodiment moves inward, the is resulting change in the effective area on which the pressure acts is modified to a significantly lesser extent during the compression travel than is the case with the purely cylindrical contour (FIG. 2). The embodiment on the left-hand side of FIG. 2 shows the greatest scope for influencing the increase in the force during compression since, in this case, the area on which the pressure acts increases sharply during compression.

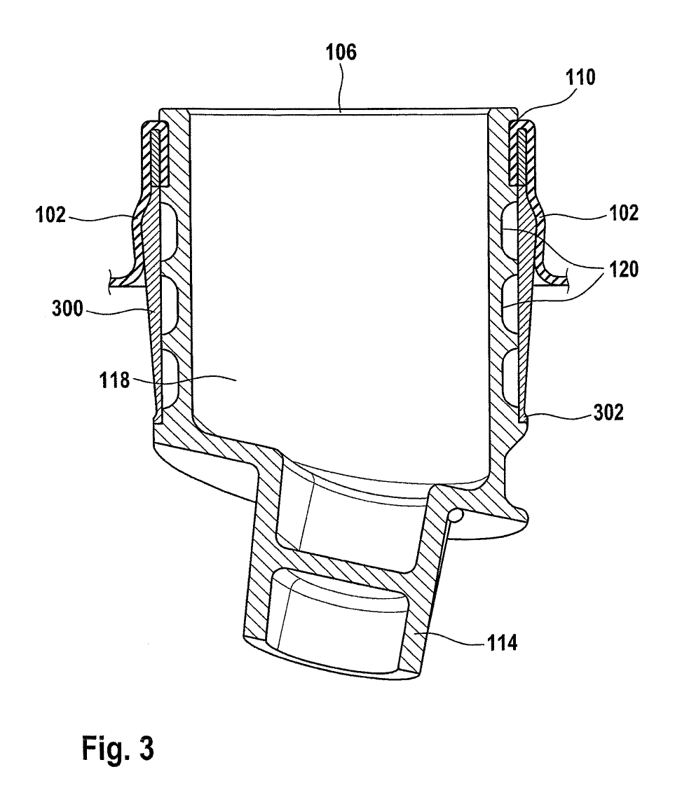

In order then to obtain this outer contour of the piston skirt, a cross-sectional view of a piston 118 is shown in FIG. 3 in which said piston 118 has a main body with a piston skirt having an outer contour 120. An interchangeable shell 300 is arranged on the outer contour 120 of the piston skirt. In this case, the interchangeable shell is firmly fixed on the piston 118. This can be achieved, for example, by using latching joints, e.g. by clicking the interchangeable shell 300 onto the piston skirt. It is also possible, in addition or as an alternative, to slide the interchangeable shell 300 onto the piston skirt from above or from below.

Whereas the original piston skirt 120 has a substantially cylindrical contour, modifying this outer contour by means of the interchangeable shell 300 results once again in a frustoconical or conical shape. In the embodiment shown in FIG. 3, the outside diameter of the piston 118 increases over a certain area in the upward direction due to the interchangeable shell 300, and then decreases continuously again. Overall, the modification of the outer contour of the piston skirt over the interchangeable shell 300 results in a modification to the air spring characteristic of the air spring.

The piston, the interchangeable shell 300 and the air spring bellows 102 are fixed to one another in region 110, i.e. in the region of the clamping plate 106, by means of a clamping ring. An airtight connection between the piston, the interchangeable shell and the air spring bellows is thus obtained.

For this purpose, the piston 118 preferably has a taper in region 110, in which the interchangeable shell 300 is pressed onto the air spring bellows 102 by the clamping ring (not shown specifically in FIG. 3). Overall, press fitting of the air spring bellows 102 onto the region of the taper in region 110 is thereby obtained.

It is thus possible to adapt the main body of the piston, defined in FIG. 3, the piston by means of the interchangeable shell 300 individually to the respective car, for example, in accordance with the attachment specifications of the respective client, through the combination of piston 118 with outer contour 120. In addition to being fixed on the piston 118, the interchangeable shell is preferably also additionally safeguarded against the development of noise. For this purpose, a further clamping ring in the lower region of the interchangeable shell and insertion of the interchangeable shell into a mating recess in the lower region of the interchangeable shell can be employed, thus ensuring that the interchangeable shell 300 is clamped firmly on the piston 118 in the lower region 302 of said shell.

It is also possible for the interchangeable shell to extend into the region of the lower fastening 114 and to be fixed there—if appropriate together with fastening means for fixing the piston 118 on a vehicle axle.

Through appropriate swapping, the interchangeable shell 300 allows great variability within a range to be defined in advance, which differs from application to application. This means, for example, that the spring rate can be adapted quickly by means of the contour of the shell.

In this context, metal or non-metallic plastic main bodies can be used for the main body 118. For the interchangeable shell 300, the first choice is plastic since it can be produced in a simple and variable manner in an injection molding process. It is thereby possible to achieve a large variety of products at low cost. However, interchangeable shells 300 made of metal could also be used here, although it must be taken into account that they must be secured against rattling and other sources of noise generation.

In the case of the embodiment in which the outer contour of the piston skirt is modified by mechanical deformation of the outer contour 120, the interior of the piston 118 can be provided with a mechanism which pushes parts of the outer contour 120 dynamically outward in a reversible manner. This can be achieved by piezoelectric or pneumatic means. Other kinds of mechanical drives are also possible in this context.

### LIST OF REFERENCE SIGNS

100 air spring
102 air spring bellows
104 beveled plate
106 clamping plate
110 region
112 direction
114 lower fastening
116 interior of the air spring bellows
118 piston
120 outer contour
300 interchangeable shell
302 region

1.-12. (canceled)

13. A piston for an air spring, wherein the piston has a piston skirt, wherein an outer contour of the piston skirt can be variably modified in order to modify an air spring characteristic of the air spring.

14. The piston as claimed in claim 13, wherein the piston has means for fixing an interchangeable shell, wherein the outer contour can be modified by fixing the interchangeable shell on the piston.

15. The piston as claimed in claim 14, wherein the piston is designed to receive the interchangeable shell by sliding the latter onto the piston skirt.

16. The piston as claimed in claim 14, wherein the means for fixing comprise latching means.

17. The piston as claimed in claim 14, wherein the piston together with the interchangeable shell can be connected in an airtight manner to an air spring bellows.

18. The piston as claimed in claim 17, wherein the piston can be connected to the interchangeable shell and the air spring bellows by a clamping ring.

19. The piston as claimed in claim 18, wherein the piston has a sealing taper, wherein the sealing taper is designed to allow an airtight connection of the piston to the interchangeable shell and the air spring bellows by the clamping ring.

20. The piston as claimed in claim 18, wherein the piston together with the interchangeable shell can be connected in an airtight manner to the air spring bellows by pressing the clamping ring onto the interchangeable shell and thereby pressing the interchangeable shell onto the air spring bellows.

21. The piston as claimed in claim 13, wherein the outer contour can be modified by mechanically distorting the outer contour of the piston skirt.

22. The piston as claimed in claim 21, wherein the distortion can be implemented by a reversible deformation of the piston skirt.

23. An air spring having a piston, wherein an outer contour of the piston skirt can be variably modified in order to modify an air spring characteristic of the air spring.

24. An interchangeable shell for a piston as claimed in claim 14.
